(19) United States
(12) Patent Application Publication
(10) Pub. No.: US 2020/0310608 A1
(43) Pub. Date: Oct. 1, 2020

(54) SYSTEM AND METHOD FOR PROVIDING REAL-TIME ASSISTANCE TO A PRESENTER FOR RENDERING CONTENT

(71) Applicant: Wipro Limited, Bangalore (IN)

(72) Inventors: Sethuraman ULAGANATHAN, Tiruchirapalli (IN); Manjunath Ramachandra, Bangalore (IN)

(21) Appl. No.: 16/442,580

(22) Filed: Jun. 17, 2019

(30) Foreign Application Priority Data
Mar. 30, 2019 (IN) 201941012928

(51) Int. Cl. G06F 3/0484; G06F 3/01; G06F 3/16; G09B 5/02; G06F 16/26; G06F 16/23

(52) U.S. Cl. CPC G06F 3/0484; G06F 3/017; G06F 16/2379; G09B 5/02; G06F 16/26; G06F 3/167

(57) ABSTRACT

Systems and methods of providing real-time assistance to a presenter for rendering of a content are disclosed. In one embodiment, the method may include receiving a multi-modal input from the presenter with respect to the rendering of the content by the presenter, and performing a real-time analysis of at least one of the multi-modal input or a historical rendering of the content by the presenter. The method may further include dynamically determining a need for providing assistance to the presenter based on the real-time analysis. The method may further include dynamically generating, in response to the need, a supporting visual content based on the real-time analysis and a plurality of contents in a content database, and dynamically rendering the supporting visual content on a rendering device in possession of the presenter based on the real-time analysis.

### TECHNICAL FIELD

This disclosure relates generally to rendering of a content, and more particularly to a system and a method of providing real-time assistance to a presenter for rendering of a content.

### BACKGROUND

Computer-based learning, also known as e-learning, has gained popularity over the recent past, because of many advantages over traditional, classroom-based learning environments. During presentation and delivery of training content by a trainer (or demonstrator) in a learning session, it may be advantageous to provide assistance, in form of real-time visual models or diagrams, that would facilitate a more impactful and effective learning for the audience. In some cases, the trainer may generate a rudimentary hand-made models or drawing, so as to enable explanation of the content in a visual manner. However, such models or drawings may not be sufficiently annotated to be able to explain the content. Moreover, some of the narrated training contents may have references to earlier sessions, but, the current session may lack an imagery of the same visual content used earlier.

In some scenarios, the trainer may attempt to fetch associated visual content from a library or database of models and drawings. However, fetching the visual content proves time-consuming, and effort-intensive exercise, and leads to disruption in the flow of the session. Although, the associated visual content may be kept ready for display by the trainer or instructor, in a pre-planned manner, there may be no provision for supporting the narration through visual content generation, in a real time manner. In some scenarios, the narration may be considerably different from the pre-planned narration, as there may be questions and doubts raised by the audience during the season. These questions and doubts may be addressed through back referencing of content already created during earlier sessions. However, such content may be absent, and, therefore, it may call for a lengthy explanation and a search for such content, so as to present the relevant back-referenced content to the audience in the current session. The searching for the content may further be an effort-intensive and time-consuming exercise.

In some scenarios, a trainer may have access to pre-planned associated visual content, but the visual content and the corresponding narrative by the trainer may not be in synchronization. Some scenarios, for example, in the field of product training, may involve usage of a product or a machine, during the presentation, and the associated content, (for example, instructions, animations, specifications, theory, details, previous and next step views) may be useful. Some augmented reality devices may be used in such scenarios, however, the augmented reality devices are static in nature and cannot not provide additional product details in an automated manner.

Some current techniques of product demonstration include a demonstrator explaining one or more usages of their product, while their voice and instructions data are captured and displayed to the users on a display unit. However, during the course of demonstration, the users (taking training) may forgot the initial steps. Some other current techniques include generating the training content on single window of a display unit. However, there is nothing to allow the demonstrator to refer back to the steps or content.

### SUMMARY

In one embodiment, a method of providing real-time assistance to a presenter for rendering of a content is disclosed. In one example, the method may include receiving a multi-modal input from the presenter with respect to the rendering of the content by the presenter. The method may further include performing a real-time analysis of at least one of the multi-modal input or a historical rendering of the content by the presenter. The method may further include dynamically determining a need for providing assistance to the presenter based on the real-time analysis. The method may further include dynamically generating, in response to the need, a supporting visual content based on the real-time analysis and a plurality of contents in a content database. The method may further include dynamically rendering the supporting visual content on a rendering device in possession of the presenter based on the real-time analysis.

In one embodiment, a system for providing real-time assistance to a presenter for rendering of a content is disclosed. In one example, the system may include a presenter assistance device that may include at least one processor and a computer-readable medium communicatively coupled to the at least one processor. The computer-readable medium may store processor-executable instructions, which, on execution, may cause the processor to receive a multi-modal input from the presenter with respect to the rendering of the content by the presenter. The processor-executable instructions, on execution, may further cause the processor to perform a real-time analysis of at least one of the multi-modal input or a historical rendering of the content by the presenter. The processor-executable instructions, on execution, may further cause the processor to dynamically determine a need for providing assistance to the presenter based on the real-time analysis. The processor-executable instructions, on execution, may further cause the processor to dynamically generate, in response to the need, a supporting visual content based on the real-time analysis and a plurality of contents in a content database. The processor-executable instructions, on execution, may further cause the processor to dynamically render the supporting visual content on a rendering device in possession of the presenter based on the real-time analysis.

In one embodiment, a non-transitory computer-readable medium storing computer-executable instruction for providing real-time assistance to a presenter for rendering of a content is disclosed. In one example, the stored instructions, when executed by a processor, may cause the processor to perform operations including receiving a multi-modal input from the presenter with respect to the rendering of the content by the presenter. The operations may further include performing a real-time analysis of at least one of the mufti-modal input or a historical rendering of the content by the presenter. The operations may further include dynamically determining a need for providing assistance to the presenter based on the real-time analysis. The operations may further include dynamically generating, in response to the need, a supporting visual content based on the real-time analysis and a plurality of contents in a content database. The operations may further include dynamically rendering the supporting visual content on a rendering device in possession of the presenter based on the real-time analysis.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a system for providing real-time assistance to a presenter for rendering of a content, in accordance with some embodiments of the present disclosure.

FIG. 2 is a functional block diagram of a presenter assistance device of the system of FIG. 1, in accordance with some embodiments of the present disclosure.

FIG. 3 is a flow diagram of an exemplary process overview of providing real-time assistance to a presenter for rendering of a content, in accordance with some embodiments of the present disclosure.

FIG. 4 is a flow diagram of an exemplary detailed process of providing real-time assistance to a presenter for rendering of a content, in accordance with some embodiments of the present disclosure.

FIG. 5 illustrates an exemplary process of receiving time stamp data by a time based search engine, in accordance with some embodiments of the present disclosure.

FIG. 6 illustrates an exemplary process of determining whether content displayed is relevant content or not, in accordance with some embodiments of the present disclosure.

FIG. 7 illustrates an exemplary process of determining summarized content, in accordance with some embodiments of the present disclosure.

FIG. 8 illustrates an exemplary Table of one or more main contents in a queue, in accordance with some embodiments of the present disclosure.

FIG. 9 illustrates an exemplary Table of one or more reference contents in a queue for appearance on at least one window, in accordance with some embodiments of the present disclosure.

FIG. 10 illustrates an exemplary process of determining a minimum time and a maximin time for which each of the reference contents in a reference queue is displayed in a display window, in accordance with some embodiments of the present disclosure.

FIG. 11 illustrates an exemplary process of determining inconsistences in one or more missed sequence or content in presenter actions and words, in accordance with some embodiments of the present disclosure.

FIG. 12 illustrates an exemplary process of computing difference between delivered content and actual contents, in accordance with some embodiments of the present disclosure.

FIG. 13 is a computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

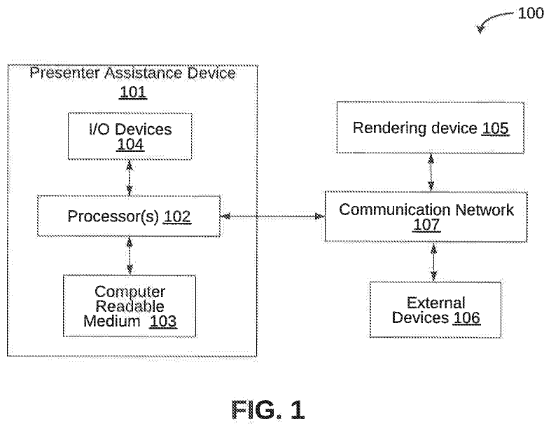

Referring now to FIG. 1, a block diagram of an exemplary system 100 for providing real-time assistance to a presenter for rendering of a content, is illustrated, in accordance with some embodiments of the present disclosure. In particular, the system 100 may implement a presenter assistance device 101 so as to provide real-time assistance to a presenter for rendering of a content. For example, the presenter assistance device 101 may dynamically render a supporting visual content during rendering of the content. To this end, the presenter assistance device 101 may be communicatively coupled to a rendering device 105, via a communication network 107. The rendering device 105 may be any display device, capable of rendering at least a visual content. The communication network 107 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

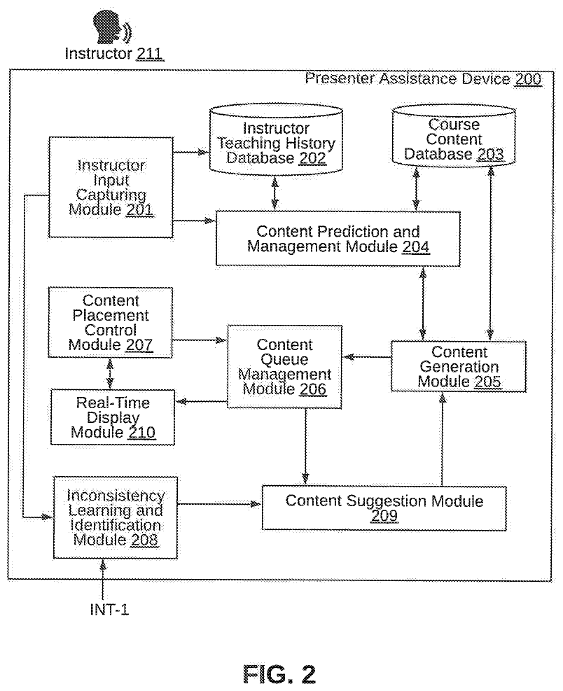

As will be described in greater detail in conjunction with FIGS. 2-12, the presenter assistance device 101 may receive a multi-modal input from the presenter with respect to the rendering of the content by the presenter. The presenter assistance device 101 may further perform a real-time analysis of at least one of the multi-modal input or a historical rendering of the content by the presenter. The presenter assistance device 101 may further dynamically determine a need for providing assistance to the presenter based on the real-time analysis. The presenter assistance device 101 may further dynamically generate, in response to the need, a supporting visual content based on the real-time analysis and a plurality of contents in a content database. The presenter assistance device 101 may further dynamically render the supporting visual content on a rendering device in possession of the presenter based on the real-time analysis.

The presenter assistance device 101 may include, but may not be limited to server, desktop, laptop, notebook, netbook, smartphone, and mobile phone. In particular, the presenter assistance device 101 may include one or more processors 102, a computer-readable medium (e.g. a memory) 103, and input/output devices 104. The computer-readable storage medium 103 may store the instructions that, when executed by the one or more processors 102, cause the one or more processors 102 to perform various functions in order to provide real-time assistance to a presenter for rendering of a content, in accordance with aspects of the present disclosure. The computer-readable storage medium 103 may also store various data (e.g. multi-modal input data, content data, real-time analysis data, supporting visual content data, sequence data, machine learning data, content database, etc.) that may be captured, processed, and/or required by the presenter assistance device 101. The presenter assistance device 101 may interact with a user (not shown) via input/output devices 104, for example, for receiving a multi-modal input from the user (presenter) with respect to rendering of content. The presenter assistance device 101 may further interact with one or more external devices 106, via the communication network 107.

Referring now to FIG. 2, a functional block diagram of a presenter assistance device 200, corresponding to the presenter assistance device 101 implemented by the system 100 of FIG. 1, is illustrated, in accordance with some embodiments of the present disclosure. The presenter assistance device 200 may include various modules that perform various functions for providing real-time assistance to a presenter for rendering of a content. In some embodiments, the presenter assistance device 200 may include an instructor input capturing module 201, an instructor teaching history database 202, a course content database 203, a content prediction and management module 204, a content generation module 205, a content queue management module 206, a content placement control module 207, an inconsistency learning and identification module 208, a content suggestion module 209, and a real-time display module 210. As will be appreciated by those skilled in the art, all such aforementioned modules and databases 201-210 may be represented as a single module or a combination of different modules. Moreover, as will be appreciated by those skilled in the art, each of the modules and databases 201-210 may reside, in whole or in parts, on one device or multiple devices in communication with each other.

The instructor input capturing module 201 may receive one or more inputs in form of instructor multi-modal instructions. The one or more inputs may include a voice, a gesture (or a touch), or a text from an instructor 211. In some embodiments, an instruction including voice may be converted into text format, for further analysis, using Natural language processing (NLP). The instructor teaching history database 202 may store instructor details and course details. The instructor teaching history database 202 may further maintain a teaching module along with teaching history, which may be used for recording a teaching sense of the instructor associated with a topic. The course content database 203 may further maintain course content prepared by the instructor. The course content may include a textual document, such as a presentation, or a video, or an audio, or an animation, and so on. The course content database 203 may be indexed by the instructor.

The content prediction and management module 204 may fetch the course content for rendering. The content prediction and management module 204 may further fetch the instructor teaching history sense, for performing prediction. It may be noted that the content prediction and management module 204 may predict the contents to be displayed in advance. The content prediction and management module 204 may then send the contents to the content queue management module 206, so that it may be ready for rendering. In some scenarios, the instructor may give explanations about a supporting concept which may be required for a main concept being taught. In such scenarios, a visual course content being displayed may not have the visuals, of the supporting course content. In such scenarios, the content prediction and management module 204 may predict the relevant content, for example, a supporting concept visual, that may be displayed. The content prediction and management module 204 may make sure that the relevant content is displayed. In some scenarios, the instructor may be back referencing certain topics without explicitly drawing or selecting them from the course content. In such scenarios, the content prediction and management module 204 may predict and complete the diagrams or equations, in advance, even before the instructor has completed them.

In some embodiments, content prediction and management module 204 may use a time based search engine (TBSE) sub-unit to predict the reference contents. The TBSE may use a content integrator to predict the relevant content to be rendered. The TBSE may further include a contextual summarisation sub unit which may be used to perform summarisation, whenever it is required. Additionally, the content prediction and management module 204 may use the TBSE to predict the reference contents.

The content generation module 205 may generate subsequent content which may be relevant to the current topic. The content generation module 205 may further send the generated content to content queue management module 206, It may be noted that the generated content may be rendered, based on a confirmation from the instructor. For example, the content generation module 205 may create the diagrams and equations in advance without instructor explicitly drawing them, based on the previous teaching history. The content generation module 205 may accept the example values provided by the instructor, and may apply them in the equations, which may show step-by-step answers, These step-by-step answers may be rendered automatically, based on the instructor conformation.

The content queue management module 206 may receive one or more contents, so that the one or more contents are ready for rendering, when required. The content queue management module 206 may be configured to present the contents in real time. By way of an example, when the instructor switches the concept back and forth, the contents may be readily available in the content queue management module 206. The content queue management module 206 may further be configured to display the one or more contents on at least two windows of a display device, for a predetermined period of time. Further, the content queue management module 206 may manage the contents in the real time. When the one or more contents are ready and queued in a content queue, along with a minimum and a maximum display time tagged to each of the one or more contents, the one or more contents may be ready for rendering by the real-time display module 210.

The content placement control module 207 may analyze the current content items and may place the contents items in an adaptive manner. It may be understood that the content placement control module 207 may place the contents items in an adaptive manner, so that the instructor hand-written text or drawings or text pages may fit in the same page. The content placement control module 207 may resize the already displayed contents, as desired. Further, the content placement control module 207 may shrink a long derivation, when it is not needed, so as to make space for other contents, based on the instructor teaching flow.

The inconsistency learning and identification module 208 may receive instructor feedback on the prediction and placement of the real time contents, and identify inconsistencies. The inconsistencies may be used by the content suggestion module 209 to suggest alternatives to the content prediction and management module 204. The inconsistency learning and identification module 208 may analyze the identified inconsistencies in the content placement and the prediction, based on the presenter's feedback. The inconsistency learning and identification module 208 may include a consistency checker. The consistency checker may further include an artificial neural network, such as a Convolutional Neural Network (CNN). The CNN may be used to learn the inconsistencies in the contents. For example, when the user wants to draw a figure, such as an ellipse, the CNN may capture hand gestures or images, and may help the user to draw by picking drawing objects from a library. However, in some cases, these drawings may not be what the user wants. In such cases, the inconsistencies may be captured by the CNN. By way of an example, the CNN may take a user input and a referencing object, to generate an object of right shape and size. However, if the presenter misses out some content while delivering, the inconsistencies between the delivered and actual sequence of content may be computed using a long short term memory (LSTM) module. The LSTM module is further explained in detail in conjunction with FIG. 12.

The content suggestion module 209 may suggest the most appropriate content, in case there is any inconsistency in the predicted or created contents. The learned inconsistencies may be used by the content suggestion module 209 for suggesting alternatives to the content generation module 205. As mentioned earlier, the content generation module 205 may generate subsequent content that may be relevant to the current topic, and may keep it ready to send the generated content to the content queue management module 206. In some embodiments, based on the instructor confirmation, the content may be rendered by the real-time display module 210. For example, the content generation module 205 may create the diagrams and equations in advance, without an instructor explicitly creating these diagrams and equations, based on the previous teaching history. The content suggestion module 209 may accept the example values given by the instructor, and may apply them in the equations, and may show the step-by-step answers. These step-by-step answers may be rendered automatically, based on the instructor conformation. The real-time display module 210 may receive the input content from the content queue management module 206 and the content placement control module 207. The real-time display module 210 may display a list of sub-contents to be displayed in a single page, for example via a display device.

It should be noted that the presenter assistance device 200 may be implemented in programmable hardware devices such as programmable gate arrays, programmable array logic, programmable logic devices, and so forth. Alternatively, the presenter assistance device 200 may be implemented in software for execution by various types of processors. An identified module of executable code may, for instance, include one or more physical or logical blocks of computer instructions which may, for instance, be organized as an object, procedure, function, or other construct. Nevertheless, the executables of an identified module need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

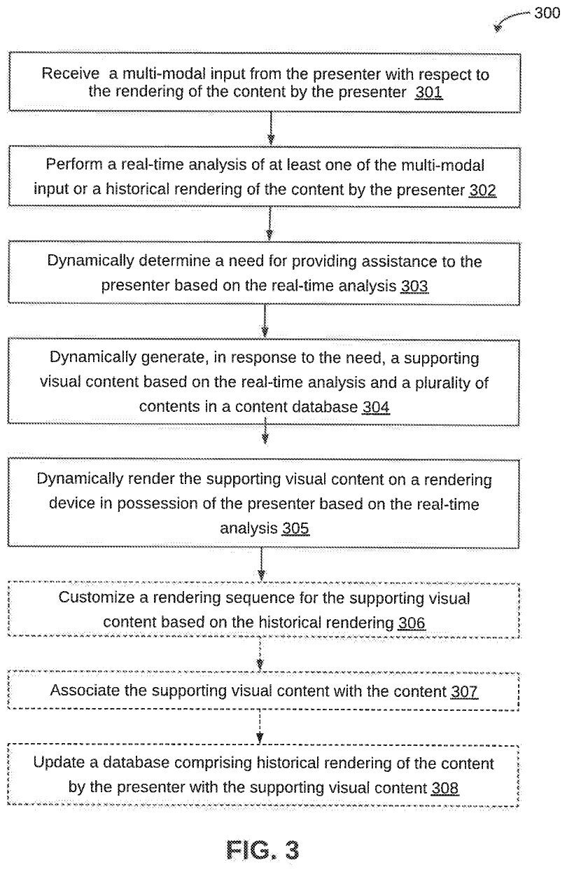

Referring now to FIG. 3, a flow diagram of an exemplary process overview for providing real-time assistance to a presenter for rendering of a content is depicted, in accordance with some embodiments of the present disclosure. As illustrated in the flowchart, a control logic 300 may include the step of receiving a multi-modal input from the presenter with respect to the rendering of the content by the presenter, at step 301. The control logic 300 may further include the step of performing a real-time analysis of at least one of the multi-modal input or a historical rendering of the content by the presenter, at step 302. The control logic 300 may further include the step of dynamically determining a need for providing assistance to the presenter based on the real-time analysis, at step 303. The control logic 300 may further include the step of dynamically generating, in response to the need, a supporting visual content based on the real-time analysis and a plurality of contents in a content database, at step 304. The control logic 300 may further include the step of dynamically rendering the supporting visual content on a rendering device in possession of the presenter based on the real-time analysis, at step 305.

In some embodiments, the control logic 300 may include one or more of following additional steps: customizing a rendering sequence for the supporting visual content based on the historical rendering, at step 306; associating the supporting visual content with the content, at step 307; and updating a database comprising historical rendering of the content by the presenter with the supporting visual content, at step 308.

At step 301, a multi-modal input may be received from the presenter with respect to the rendering of the content by the presenter. In some embodiments, the multi-modal input may include at least one of a voice of the presenter, a gesture made by the presenter, a text written by the presenter, or a content selected by the presenter. At step 302, a real-time analysis may be performed of at least one of the multi-modal input or a historical rendering of the content by the presenter. In some embodiments, performing the real-time analysis may include determining at least one of a short-coming in a portion of the content, an inconsistency in a portion of the content, or an indication by the presenter. In such embodiments, determining the short-coming may further include determining a gap in the content with respect to the multi-modal input.

At step 303, a need for providing assistance to the presenter may be dynamically determined, based on the real-time analysis. At step 304, in response to the need, a supporting visual content may be dynamically generated, based on the real-time analysis and a plurality of contents in a content database. In some embodiments, dynamically generating the supporting visual content may include identifying a relevant content from among the plurality of contents based on the real-time analysis using a machine learning algorithm. It should be noted that, in some embodiments, upon identification of the relevant content, the supporting visual content may be extracted from the relevant content. In some embodiments, dynamically generating the supporting visual content may further include determining a relevancy of the supporting visual content with respect to the content or determining a relevancy a portion of the supporting visual content with respect to remaining portions of the supporting visual content.

At step 305, the supporting visual content may be dynamically rendered on a rendering device in possession of the presenter based on the real-time analysis. In some embodiments, dynamically rendering the supporting visual content may include determining a placement of the supporting visual content with respect to the content based on at least one of a context of the supporting visual content, or a size of the supporting visual content. In some embodiments, dynamically rendering the supporting visual content may further include dynamically rendering the supporting visual content on the rendering device contemporaneously with rendering of a content selected by the presenter.

At step 306, a rendering sequence for the supporting visual content may be customized, based on the historical rendering. At step 307, the supporting visual content may be associated with the content. At step 308, a database comprising historical rendering of the content may be updated by the presenter with the supporting visual content.

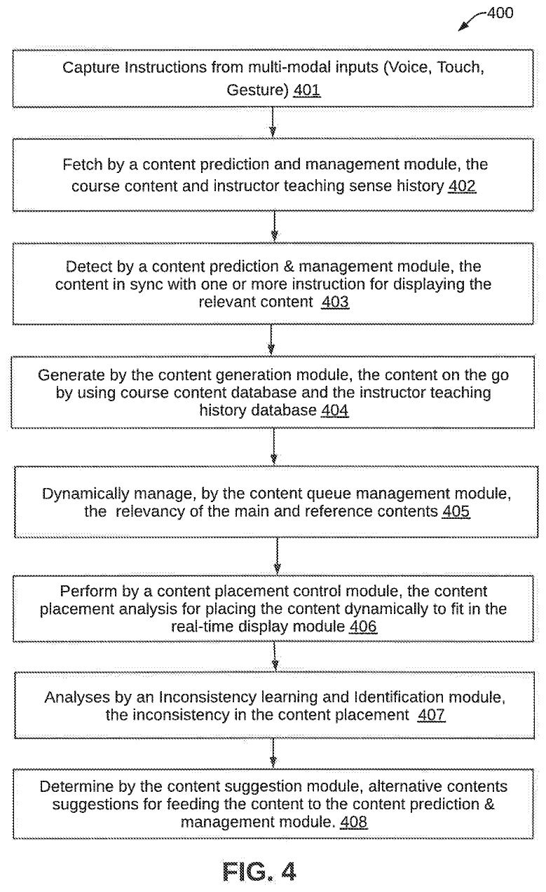

Referring now to FIG. 4, an exemplary process 400 for providing real-time assistance to a presenter for rendering of a content is depicted in greater detail, via a flowchart, in accordance with some embodiments of the present disclosure. At step 401, one or more instructions may be captured from multi-modal inputs (for example voice, touch, gesture, etc.). At step 402, course content and instructor teaching sense history may be captured. At step 403, it may be detected whether the content is in sync with the one or more instructions, for displaying the relevant content. At step 404, content on the go may be generated by using course content database and the instructor teaching history database. At step 405, relevancy of main and reference content may be dynamically managed. At step 406, content placement analysis may be performed for placing the content dynamically to fit in a real-time display module. At step 407, inconsistencies in the content placement may be analyzed. At step 408, alternative contents suggestions may be determined.

At step 401, one or more instructions may be captured from multi-modal inputs (for example voice, touch, gesture, etc.). In some embodiments, an instructor input capturing module 201 may capture the one or more instructions. It may be noted that the inputs may be in form of one or more of a voice, a gestures, or a text from an instructor. In some embodiments, at least one instruction including voice may be converted to text format, for further analyzing, using Natural language processing (NLP).

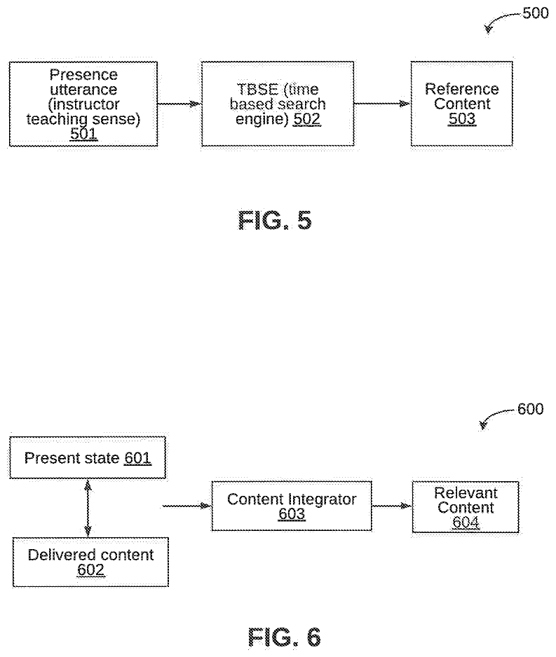

At step 402, the course content and instructor teaching sense history may be captured. In some embodiments, the course content and the instructor teaching sense history may be received by a content prediction and management module 204 from a course content database 203 and an instructor teaching history database 202, respectively. The content prediction and management module 204 may be triggered by a plurality of conditions, such when a user is stuck, when a query is raised, or when a user is refreshed for effective presentation. It may be understood that the fetched course content and the instructor teaching sense history may be relevant to a current topic. In some embodiments, the course content may be fetched for rendering, and the instructor teaching history sense for predicting. Further, at step 402, the contents to be displayed may be predicted, in advance. In alternative embodiments, the fetching of the course content may take place in a predetermined order, based on the course content. It should be noted that one or more fetched contents may be rendered in a main window of a display screen. In some embodiments, a secondary window (i.e. a reference window) may be located at the side by the main window to render a back referenced topic. The secondary window may be created dynamically based on the back referencing. In some embodiments, a time based search engine (TBSE) may be used to predict a reference content. It may be noted that a time stamp and parsed words may be used to provide the relevant referenced content. The process of receiving time stamp data is further explained in detail, in conjunction with FIG. 5.

Referring now to FIG. 5, an exemplary process 500 of receiving time stamp data by a time based search engine (TBSE), is illustrated, in accordance with some embodiments of the present disclosure. In some embodiments, an output generated by the TBSE 502 may vary with time for the same keywords input. By way of an example, when an instructor may present a presence utterance 501 in the beginning, the reference window (i.e. the secondary window) may show reference content 503. However, at some point of time, the reference window may show a different content for the same utterance. This may be because, the instructor would have already shown the reference relevant at that point of time and showing the same result again may not be desirable. For example, during a mixer grinder product demonstration, a product demonstrator (i.e., instructor) may provide an explanation utterance on how to connect power supply, next jars and, and next blades. In addition to explaining about blades, the product demonstrator may also demonstrate a summarized view of the corresponding jar, as reference. Further the product demonstrator may explain about a lid, and then how to run or the like. When demonstrator forgets to utter one or more explanations, those explanations may be provided in the reference window (or the secondary window), as a reminder. Further, when the product demonstrator wants to cross-refer a portion of the explanation, the corresponding portion may re-appear. It may be understood that the re-appearance of that data may occur with the help of current state in workflow blended with parsed words into the TBSE 502.

Returning back to FIG. 4, at step 403, it may be detected whether the content is in sync with the one or more instructions for displaying the relevant content, and to generate the diagrams and equations. In some embodiments, the detection may be carried out by a content prediction and management module 204. In other words, the content prediction and management module 204 may detect whether the content is relevant content or not, and whether the content to be displayed on a digital display unit is in sync with the one or more instructions from the instructor or not. The process of determining whether the content displayed is relevant content or not, is further explained in detail, in conjunction with FIG. 6.

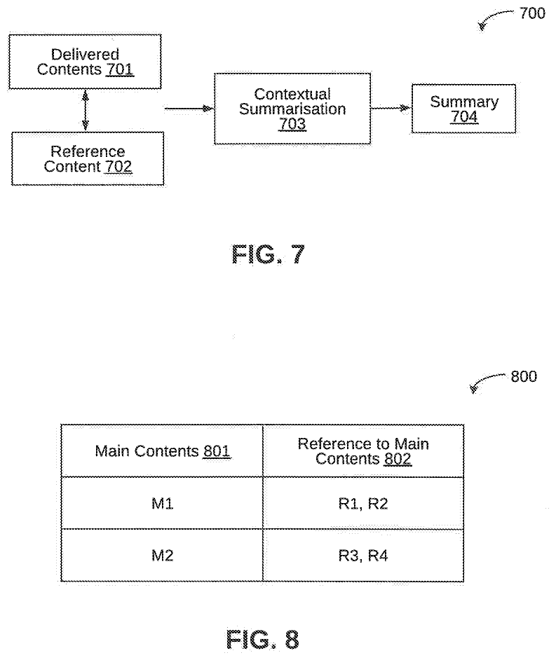

Referring now to FIG. 6, an exemplary process 600 of determining whether the content displayed is relevant content or not is illustrated, in accordance with some embodiments of the present disclosure. In some embodiments, the content prediction and management module 204 may determine whether the content displayed is relevant content or not. The content prediction and management module 204 may include a content integrator 603 which may detect whether a relevant content 604 may be rendered. In some embodiments, the content integrator 603 may use a multi-layer neural network. By using the content integrator 603, a present state 601 of the content may be determined. The present state 601 may be determined by default flow, or by one or more overrides by a presenter for choice of topics. In some embodiments, the content may be delivered (i.e., delivered content 602) in planned sequence without additions or omissions. The delivered content 602 may adhere to a predefined sequence (for example, a Table of content, sections and sub sections). These references may be stored as golden references. It may be understood that a difference or deviation in the relevant content 604 may determine where the presenter may need to change the sequence, as well what omissions are made. Once it is determined whether the content displayed is relevant content or not, a summarized content may be determined. The process of determining the summarized content is further explained in detail, in conjunction with FIG. 7.

Referring now to FIG. 7 an exemplary process 700 of determining summarized content is depicted, in accordance with some embodiments of the present disclosure. A summarized content (i.e., summary 704) may be determined by the content prediction and management module 204 (not shown in FIG. 7). The content prediction and management module 204 may contain a contextual summarisation sub-module which may be configured to perform the summarisation, when it is required. The content prediction and management module 204 may deliver a contextual summarization 703 of delivered content 701, when at least a portion of the delivered content 701 misses out the required flow of content between two time-snap shots. The contextual summarisation 703 of reference content 702 may depend on the delivered content 701. In some cases, the summary 704 may not contain much of the delivered content 701. In some cases, the delivered content 701 and non-delivered content may be in 4:6 ratio, which may be further multiplied by a relative importance of the piece of content to be referenced or refreshed. It may be noted that this piece of content to be referenced may be predetermined. When the predetermined reference content 702 at a point is not covered already, the summarization may be less (i.e. 6:4).

Referring back to FIG. 4, at step 404, the content on the go may be generated. In some embodiments, a content generation module 205 may generate the content on the go, based on the need, by using a course content database 203 and an instructor teaching history database 202. The content generation module 205 may generate subsequent contents that may be relevant to the current topic and keep them ready, and send the generated contents to a content queue management module 206. In some embodiments, based on the instructor confirmation, the content may be rendered (for example, by a real time display module 210). Thereafter, diagrams and equations may be created in advance without the instructor explicitly making the diagrams and equations, based on the previous teaching history. One or more values given by the instructor may be applied to the equations. In some embodiments, step-by-step answers, which may be rendered automatically, based on the instructor conformation, may be shown.

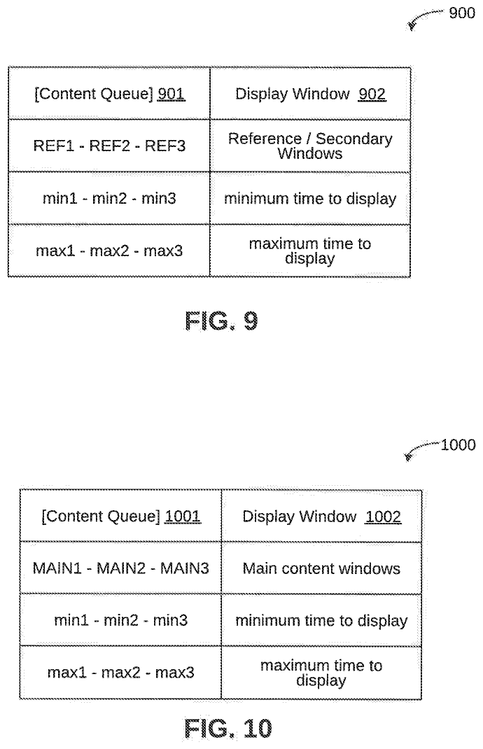

At step 405, relevancy of main and reference content may be dynamically managed. In some embodiments, the content queue management module 206 may manage the contents in real time. When the instructor switches the concept back and forth, the contents may be readily available in the content queue management module 206. When the contents are ready and queued in the content queue along with the minimum and maximum display time tagged to it, the contents may be ready for rendering. The managing of the contents is further explained in detail in conjunction with FIGS. 8 and 9.

Referring now to FIG. 8, a Table 800 including one or more main contents in a queue is illustrated, in accordance with some embodiments of the present disclosure. The Table may provide the relation between the main content and its corresponding referenced content. The column 801 may include a queue of the one or more main content, and the column 802 may include the corresponding references content. By way of an example, main content M1 and the referenced content R1 and R2 may be related to each other. Similarly, main content M2 and referenced content R3 and R4 may be related to each other. As shown, the related contents may be displayed side by side.

Referring now to FIG. 9, a Table 900 including one or more reference contents in a queue for appearance on at least one window 902, is depicted in accordance with some embodiments of the present disclosure. It may be noted that the reference contents in a queue may appear on at least one window 902, for a predetermined period of time. In some embodiments, a content queue 901 may include one or more reference contents REF1, REF2, REF3. Each of the one or more reference content may correspond to appearance on at least one display window for a predetermined period of time. For example, the Table 900 may include a minimum time (min1, min2, min3) and minimum time (max1, max2, max3) for each of the one or more reference contents REF1, REF2, REF3, for which the reference contents may be displayed. In some embodiments, at least one content in the form of one or more contents being fetched may depend on the course of presentation flow. This at least one content may be predetermined. However, the at least one content may depend on a one or more uncertain factors, which may include a presenter's sequence of flow (including choice of words), user queries until that point, and whether the user is stuck over some topic (for example, during training). In some embodiments, there may be secondary or referenced contents along with main contents. It may be noted that there may be a need to determine how long the predicted reference content may have to be displayed in the secondary window, and when a new secondary window should be displayed. The process of determining the minimum time and the maximum time for which the reference contents may be displayed, is further explained in detail in conjunction with FIG. 10.

Referring now to FIG. 10, an exemplary process 1000 of determining a minimum time and a maximum time for which each of the reference contents in the reference queue 1001 may be displayed in a display window 1002, is depicted in accordance with some embodiments of the present disclosure. In some embodiments, the minimum time (min1, min2, min3) corresponding to main the content (MAIN1, MAIN2, MAIN3) may be based on rate of delivery of the main content (MAIN1, MAIN2, MAIN3). The maximum time (max1, max2, max3) corresponding to main the content (MAIN1, MAIN2, MAIN3) may be determined by the queue length along with the context of the presenter's flow. The main contents and the secondary contents may be synchronized. In some scenarios, size of main contents MAIN2 may be larger than main contents MAIN1. In such cases, the main contents MAIN2 may be downsized automatically to fit in the display. In some embodiments, neural network based regression may be used to decide the resizing factor for the bigger content or smaller content, as required. Accordingly, the display screen may be occupied adaptively.

Returning back to FIG. 4, at step 406, the content placement analysis may be performed for placing the content dynamically so as to fit in the display window. It may be noted that the display window may be provided by the real-time display module 210. In may be understood that the contents may be ready in the content queue along with the minimum and maximum display time tagged to it, for rendering by the real time display module 210. By way of an example, a displayed message “It is ready for rendering in the real-time display unit” may be shown which may imply that the content is fetched in advance to render (as the sequence of main content and appropriate references is known). It may be noted that there may be more than one reference contents. It may be further noted that the duration of stay of each of reference content may not be fixed, and each of reference content may stay as long the presenter is referring to reference contents. Further, the reference contents may need to be queued. Accordingly, there may be a minimum time of staying, so that the presenter may refer to the reference contents. Further, there may be a maximum time of staying, so that other references can be displayed. The placement of the contents may be decided by a content placement control module 207, based on the context and the size of the contents.

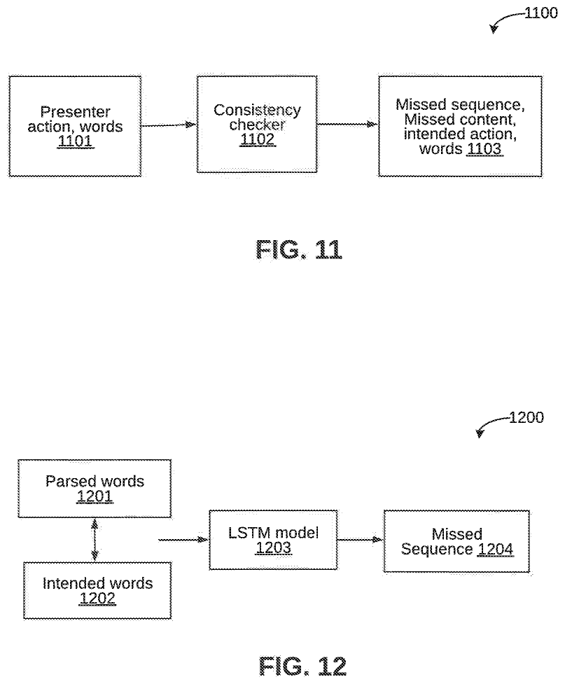

At step 407, inconsistencies in the content placement may be analyzed. The inconsistencies in the content placement may be analyzed by an inconsistency learning and identification module 208, based on the presenter's feedback. In some embodiments, the inconsistency learning and identification module 208 may further include a consistency checker. The consistency checker may include a Convolutional Neural Networks (CNN) classifier, which may be used to learn the inconsistencies in the contents. The consistency checker is further explained in detail, in conjunction with FIG. 11. By way of an example, when the user wants to draw a figure, such as an ellipse, the system may capture hand gestures or images, and may help the user to draw by picking drawing objects from a library. However, the figure obtained may not be what the user desired. Accordingly. these differences or inconsistencies may be captured through the CNN. The CNN may take a user input and a referencing object, to come out with right shape and size of the object. Further, if the presenter misses out some content while delivering, the difference between delivered and actual sequence of content may be computed through a long short term memory model (LSTM), as explained in detail in conjunction with FIG. 12.

Referring now to FIG. 11, an exemplary process 1100 of determining inconsistences in one or more missed sequence or content in presenter actions and words is illustrated, in accordance with some embodiments of the present disclosure. In some cases, there may be differences between the rendered contents and the intended content to be delivered (as per the course content). The rendered contents may include presenter actions and words 1101 (i.e. contents delivered by the presenter). For example, the presenter may have forgotten certain topics from the flow of course content. As such, inconsistencies may arise if the presenter misses out sequence or some content. These inconsistencies may be detected by a consistency checker 1102, by comparing the rendered contents with the intended actions and words, for example, by parsing the actions and words. The missed content 1103, which may include missed sequence, intended action and words, may be summarized and rendered in the reference window.

Referring now to FIG. 12, an exemplary process 1200 of computing difference between delivered/rendered content and actual sequence of contents is illustrated, in accordance with some embodiments of the present disclosure. The difference between the delivered content and actual sequence of contents may be computed using a bidirectional long short term memory (LSTM) model 1203. In some embodiments, the user may be prompted from getting in to miss-sequence by fusing a combination of parsed words and gestures 1201. The gestures may include one or more actions. The one or more actions and the one or more parsed words, may be fed to the bi-directional LSTM model 1203 along with intended action and parsed words 1202. The LSTM model 1203 may be trained for identifying missed actions, sequence, words. Accordingly, the LSTM model 1203 may provide, as output, missed actions, sequence, and words 1204.

Returning back to FIG. 4, at step 408, alternative contents suggestions may be determined for feeding the content. The alternative contents suggestions may be determined for feeding to the content prediction and management module 204. In some embodiments, the inconsistencies detected by the Inconsistency learning and identification module 208, may act as triggers, which may be used by the content suggestion module 209 to suggest the alternatives, to the content prediction and management module 204. The content suggestion module 209 may receive the presenter or instructor inputs to correct the inconsistencies (as an alternate suggestion for each of the inconsistencies). The content suggestion module 209 may determine the content suggestions (as alternatives) from the learned inconsistencies, and the currently queued contents corresponding to an associated related inconsistency. In some embodiments, the alternate suggestions may be fed to the content generation module 205 to create new content on its own, or with the help of internet fetched contents.

In some embodiments, determining the alternative contents suggestions may further include associating the reference content. By way of an example, once the presenter shows some extra reference content based on user request or questions, this reference content may get linked with the main window content. A table may maintain the address of this reference content (that may be there on the internet or on local servers). The table may further include presenter's audio explanations captured with microphone and gestures captured from a video. Additionally or alternately, determining the alternative contents suggestions may further include removing redundancies. It may be noted that repetitions may occur during the presentation from multiple references. These repetitions may be removed by comparing the keywords of content or summaries. Additionally or alternately, determining the alternative contents suggestions may further include suggesting alternative content. By way of an example, from the subsequent presentations, the linked content may get popped up in reference window along with the main content.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

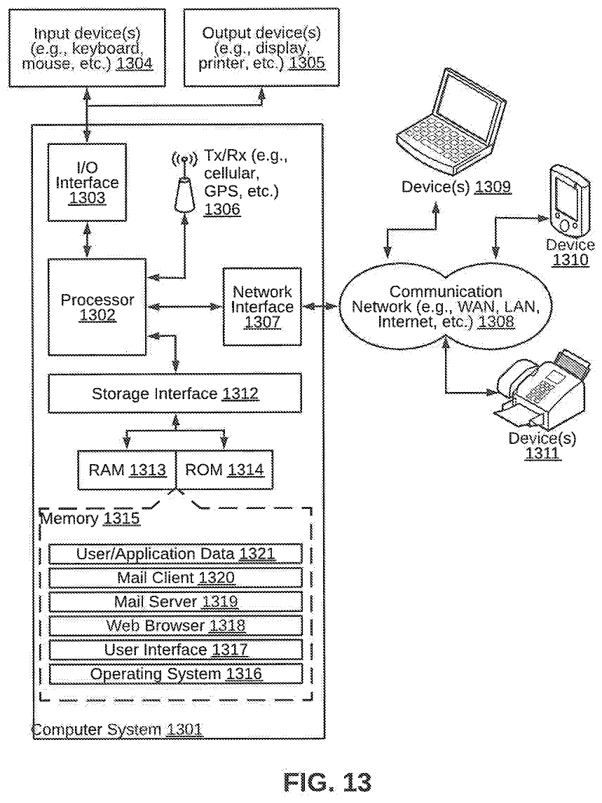

The disclosed methods and systems may be implemented on a conventional or a general-purpose computer system, such as a personal computer (PC) or server computer. Referring now to FIG. 13, a block diagram of an exemplary computer system 1301 for implementing embodiments consistent with the present disclosure is illustrated. Variations of computer system 1301 may be used for implementing system 100 for providing real-time assistance to a presenter for rendering of a content. Computer system 1301 may include a central processing unit (“CPU” or “processor”) 1302. Processor 1302 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, or the like. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, or the like. The processor 1302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), or the like.

Processor 1302 may be disposed in communication with one or more input/output (I/O) devices via I/O interface 1303. The I/O interface 1303 may employ communication protocols/methods such as, without limitation, audio, analog, digital, monoaural, RCA, stereo, IEEE-1394, near field communication (NFC), FireWire, Camera Link®. GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n /b/g/n/x, Bluetooth, cellular (for example, code-division multiple access (CDMA), high-speed packet access (HSPA+), global system for mobile communications (GSM), long-term evolution (LTE), WiMAX, or the like), or the like.

Using the I/O interface 1303, the computer system 1301 may communicate with one or more I/O devices. For example, the input device 1304 may be an antenna, keyboard, mouse, joystick, (infrared) remote control, camera, card reader, fax machine, dongle, biometric reader, microphone, touch screen, touchpad, trackball, sensor (For example accelerometer, light sensor, GPS, altimeter, gyroscope, proximity sensor, or the like), stylus, scanner, storage device, transceiver, video device/source, visors, or the like. Output device 1305 may be a printer, fax machine, video display (For example cathode ray tube (CRT), liquid crystal display (LCD), light-emitting diode (LED), plasma, or the like), audio speaker, or the like. In some embodiments, a transceiver 1306 may be disposed in connection with the processor 1302. The transceiver may facilitate various types of wireless transmission or reception. For example, the transceiver may include an antenna operatively connected to a transceiver chip (For example TEXAS INSTRUMENTS@ WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, or the like.

In some embodiments, the processor 1302 may be disposed in communication with a communication network 1308 via a network interface 1307. The network interface 1307 may communicate with the communication network 1308. The network interface may employ connection protocols including, without limitation, direct connect, Ethernet (For example, twisted pair 10/100/1000 Base T), transmission control protocol/internet protocol (TCP/IP), token ring, IEEE 802.11a/b/g/n/x, or the like. The communication network 1308 may include, without limitation, a direct interconnection, local area network (LAN), wide area network (WAN), wireless network (For example using Wireless Application Protocol), the Internet, or the like. Using the network interface 1307 and the communication network 1308, the computer system 1301 may communicate with devices 1309, 1310, and 1311. These devices may include, without limitation, personal computer(s), server(s), fax machines, printers, scanners, various mobile devices such as cellular telephones, smartphones (For example APPLE@ IPHONE®, BLACKBERRY® smartphone, ANDROID® based phones, or the like.), tablet computers, eBook readers (AMAZON@ KINDLE®, NOOK® or the like.), laptop computers, notebooks, gaming consoles (MICROSOFT® XBOX®, NINTENDO® DS®, SONY® PLAYSTATION®, or the like.), or the like. In some embodiments, the computer system 1301 may itself embody one or more of these devices.

In some embodiments, the processor 1302 may be disposed in communication with one or more memory devices (For example RAM 1313, ROM 1314, or the like.) via a storage interface 1312. The storage interface may connect to memory devices including, without limitation, memory drives, removable disc drives, or the like, employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, or the like. The memory drives may further include a drum, magnetic disc drive, magneto-optical drive, optical drive, redundant array of independent discs (RAID), solid-state memory devices, solid-state drives, or the like.

The memory devices may store a collection of program or database components, including, without limitation, an operating system 1316, user interface application 1317, web browser 1318, mail server 1319, mail client 1320, user/application data 1321 (For example any data variables or data records discussed in this disclosure), or the like. The operating system 1316 may facilitate resource management and operation of the computer system 1301. Examples of operating systems include, without limitation, APPLE® MACINTOSH® OS X, UNIX, Unix-like system distributions (For example Berkeley Software Distribution (BSD), FreeBSD, NetBSD, OpenBSD, or the like.), Linux distributions (For example RED HAT®, UBUNTU®, KUBUNTU®, or the like.), IBM® OS/2, MICROSOFT® WINDOWS® (XP®, Vista®/7/8, or the like.), APPLE® IOS®, GOOGLE® ANDROID®, BLACKBERRY® OS, or the like. User interface 1317 may facilitate display, execution, interaction, manipulation, or operation of program components through textual or graphical facilities. For example, user interfaces may provide computer interaction interface elements on a display system operatively connected to the computer system 1301, such as cursors, icons, check boxes, menus, scrollers, windows, widgets, or the like. Graphical user interfaces (GUIs) may be employed, including, without limitation, APPLE® MACINTOSH® operating systems' AQUA® platform, IBM® OS/2®, MICROSOFT® WINDOWS® (For example AERO®, METRO®, or the like.), UNIX X.WINDOWS, web interface libraries (For example ACTIVEX®, JAVA®, JAVASCRIPT®, AJAX®, HTML, ADOBE® FLASH®, or the like.), or the like.

In some embodiments, the computer system 1301 may implement a web browser 1318 stored program component. The web browser may be a hypertext viewing application, such as MICROSOFT® INTERNET EXPLORER®, GOOGLE® CHROME®, MOZILLA® FIREFOX®, APPLE® SAFARI®, or the like. Secure web browsing may be provided using HTTPS (secure hypertext transport protocol), secure sockets layer (SSL), Transport Layer Security (TLS), or the like. Web browsers may utilize facilities such as AJAX®, DHTML, ADOBE® FLASH®, JAVASCRIPT®, JAVA®, application programming interfaces (APIs), or the like. In some embodiments, the computer system 1301 may implement a mail server 1319 stored program component. The mail server may be an Internet mail server such as MICROSOFT® EXCHANGE®, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, or the like. The mail server may utilize communication protocols such as Internet message access protocol (IMAP). messaging application programming interface (MAPI), MICROSOFT® EXCHANGE®, post office protocol (POP), simple mail transfer protocol (SMTP), or the like. In some embodiments, the computer system 1301 may implement a mail client 1320 stored program component. The mail client may be a mail viewing application, such as APPLE MAIL®, MICROSOFT ENTOURAGE®, MICROSOFT OUTLOOK®, MOZILLA THUNDERBIRD®, or the like.

In some embodiments, computer system 1301 may store user/application data 1321, such as the data, variables, records, or the like. (For example course content, multi-modal inputs, Instructor teaching history, reference content, present state, delivered content, relevant content, summary, missed sequence, missed content, intended words, intended action, parsed words, predefined sequence, Table of content, sections, sub sections and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (For example XML), table, or as object-oriented databases (For example using OBJECTSTORE®, POET®, ZOPE®, or the like.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above are not routine, or conventional, or well understood in the art. The techniques discussed above provide real-time assistance to a presenter for rendering of a content. In particular, the techniques provide an improved solution in which one or more relevant contents are automatically displayed in real time on a display device, for example, when an instructor is back referencing certain topics. Therefore, the techniques provide for a time efficient and an effort efficient solution. Further, the techniques do away with the requirement of disrupting an ongoing session, and therefore allow for smooth presentation of contents. Further, the techniques may generate diagrams and equations in advance without an instructor explicitly drawing the diagrams and equations, based on the instructor teaching history. The techniques may resize the already displayed contents wisely on the display device, in real time (for example, long derivations may be shrunk, when not needed, so as to provide space for other contents). The techniques may automatically generate each and every subsequent contents that may be relevant to a current topic and keep it ready, based on the instructor confirmation. Further, the techniques may recognize new topics and concepts being explained by the instructor (i.e. other than the regular course contents), and record them for future use. Further, the techniques provide for an accurate synchronization of a content with a corresponding narrative by the instructor. The techniques are adaptable with various different languages. Moreover, the techniques are self-learning, and capable of improving itself over time. Therefore, by way of implementing the above techniques, the overall experience of presenting content, for example for e-learning, is improved.

The specification has described method and system for providing real-time assistance to a presenter for rendering of a content. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, or the like, of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of providing real-time assistance to a presenter for rendering of a content, the method comprising:
receiving, by a presenter assistance device, a multi-modal input from the presenter with respect to the rendering of the content by the presenter;
performing, by the presenter assistance device, a real-time analysis of at least one of the multi-modal input or a historical rendering of the content by the presenter;
dynamically determining, by the presenter assistance device, a need for providing assistance to the presenter based on the real-time analysis;
dynamically generating, by the presenter assistance device in response to the need, a supporting visual content based on the real-time analysis and a plurality of contents in a content database; and
dynamically rendering, by the presenter assistance device, the supporting visual content on a rendering device in possession of the presenter based on the real-time analysis.

2. The method of claim 1, further comprising customizing a rendering sequence for the supporting visual content based on the historical rendering.

3. The method of claim 1, wherein the multi-modal input comprises at least one of a voice of the presenter, a gesture made by the presenter, a text written by the presenter, or a content selected by the presenter.

4. The method of claim 1, wherein performing the real-time analysis comprises determining at least one of: a short-coming in a portion of the content, an inconsistency in a portion of the content, or an indication by the presenter.

5. The method of claim 4, wherein determining the short-coming comprises determining a gap in the content with respect to the multi-modal input or the historical rendering of the content.

6. The method of claim 1, wherein dynamically generating the supporting visual content comprises at least one of:
identifying a relevant content from among the plurality of contents based on the real-time analysis using a machine learning algorithm; and
extracting the supporting visual content from the relevant content.

7. The method of claim 1, wherein dynamically generating the supporting visual content comprises at least one of:
determining a relevancy of the supporting visual content with respect to the content; or
determining a relevancy of a portion of the supporting visual content with respect to remaining portions of the supporting visual content.

8. The method of claim 1, wherein dynamically rendering the supporting visual content comprises determining a placement of the supporting visual content with respect to the content based on at least one of a context of the supporting visual content, or a size of the supporting visual content.

9. The method of claim 1, wherein dynamically rendering the supporting visual content comprises dynamically rendering the supporting visual content on the rendering device contemporaneously with rendering of a content selected by the presenter.

10. The method of claim 1, further comprising at least one of:
associating the supporting visual content with the content; and
updating a database comprising historical rendering of the content by the presenter with the supporting visual content.

11. A system for providing real-time assistance to a presenter for rendering of a content, the system comprising:
a presenter assistance device comprising at least one processor and a computer-readable medium storing instructions that, when executed by the at least one processor, cause the at least one processor to perform operations comprising:
receiving a multi-modal input from the presenter with respect to the rendering of the content by the presenter;
performing a real-time analysis of at least one of the multi-modal input or a historical rendering of the content by the presenter;
dynamically determining a need for providing assistance to the presenter based on the real-time analysis;
dynamically generating, in response to the need, a supporting visual content based on the real-time analysis and a plurality of contents in a content database; and
dynamically rendering the supporting visual content on a rendering device in possession of the presenter based on the real-time analysis.

12. The system of claim 11, wherein the operations further comprise customizing a rendering sequence for the supporting visual content based on the historical rendering.

13. The system of claim 11, wherein the multi-modal input comprises at least one of a voice of the presenter, a gesture made by the presenter, a text written by the presenter, or a content selected by the presenter.

14. The system of claim 11, wherein performing the real-time analysis comprises determining at least one of: a short-coming in a portion of the content, an inconsistency in a portion of the content, or an indication by the presenter.

15. The system of claim 14, wherein determining the short-coming comprises determining a gap in the content with respect to the multi-modal input or the historical rendering of the content.

16. The system of claim 11, wherein dynamically generating the supporting visual content comprises at least one of:
identifying a relevant content from among the plurality of contents based on the real-time analysis using a machine learning algorithm; and
extracting the supporting visual content from the relevant content.

17. The system of claim 11, wherein dynamically generating the supporting visual content comprises at least one of:
determining a relevancy of the supporting visual content with respect to the content; or
determining a relevancy of a portion of the supporting visual content with respect to remaining portions of the supporting visual content.

18. The system of claim 11, wherein dynamically rendering the supporting visual content comprises at least one of:
determining a placement of the supporting visual content with respect to the content based on at least one of a context of the supporting visual content, or a size of the supporting visual content; or
dynamically rendering the supporting visual content on the rendering device contemporaneously with rendering of a content selected by the presenter.

19. The system of claim 11, wherein the operations further comprise at least one of:
associating the supporting visual content with the content; and
updating a database comprising historical rendering of the content by the presenter with the supporting visual content.

20. A non-transitory computer-readable medium storing computer-executable instructions for providing real-time assistance to a presenter for rendering of a content, the computer-executable instructions configured for;
receiving a multi-modal input from the presenter with respect to the rendering of the content by the presenter;
performing a real-time analysis of at least one of the multi-modal input or a historical rendering of the content by the presenter;
dynamically determining a need for providing assistance to the presenter based on the real-time analysis;
dynamically generating, in response to the need, a supporting visual content based on the real-time analysis and a plurality of contents in a content database; and
dynamically rendering the supporting visual content on a rendering device in possession of the presenter based on the real-time analysis.
